(19) United States
(12) Patent Application Publication
(10) Pub. No.: US 2018/0109557 A1
(43) Pub. Date: Apr. 19, 2018

(54) SOFTWARE DEFINED NETWORK CAPABLE OF DETECTING DDoS ATTACKS USING ARTIFICIAL INTELLIGENCE AND CONTROLLER INCLUDED IN THE SAME

(71) Applicant: FOUNDATION OF SOONGSIL UNIVERSITY INDUSTRY COOPERATION, Seoul (KR)

(72) Inventors: Myungsik Yoo, Seoul (KR); Tri Hai Nguyen, Seoul (KR); Jin Seok Choi, Seoul (KR)

(21) Appl. No.: 15/692,320

(22) Filed: Aug. 31, 2017

(30) Foreign Application Priority Data
Oct. 17, 2016 (KR) 10-2016-0134383

(51) Int. Cl. H04L 29/06; H04L 12/801; H04L 12/26

(52) U.S. Cl. CPC H04L 63/1458; H04L 47/11; H04L 43/0876; H04L 63/1425; H04L 63/1416; H04L 43/16

(57) ABSTRACT

Software defined network for detecting a DDoS attack using artificial intelligence and a controller included in the same are disclosed. The software defined network includes a controller arranged on a control plane of the software defined network, and a plurality of switches arranged on a data plane of the software defined network. Here, each of the switches collects flow which is aggregation of packets and transmits feature information concerning the flow to the controller, and the controller detects a DDoS attack by using the feature information concerning the flow and a back propagation neural network (BPNN).

### PRIORITY

This application claims priority under 35 U.S.C. §119(a) to a Korean patent application filed on Oct. 17, 2016 in the Korean Intellectual Property Office and assigned Serial No. 10-2016-0134383, the entire disclosure of which is incorporated herein by reference.

### TECHNICAL FIELD

The present disclosure relates to a software defined network SDN capable of detecting DDoS attacks by using artificial intelligence and a controller included in the same.

### BACKGROUND ART

Internet plays inseparably an important role in our daily life, and it is predicted that role of Internet increases when internet of thing IoT is really applied to daily life. However, conventional network equipment operates according to a preset rule, and thus it is difficult to manage it and it is inconvenient that every related equipment must be updated or exchanged when new function is added. It seems that the network equipment is weak to various new malicious attacks in security.

Accordingly, a software defined network SDN has been developed to solve the above problem. Unlike the conventional network equipment, a control plane and a data plane are divided in the SDN. As a result, network architecture is simple, the network is flexibly managed, and the network is partially stronger to malicious attacks than the conventional network. However, the SDN does not provide perfect solution in security and it has still weakness in security.

Specially, DDoS attack means an attack in which attackers in distributed arrangement perform simultaneously denial of service attack DoS, and so a system cannot provide normal service. That is, the DDoS attack attacks simultaneously a specific destination with remote computers by infecting many remote computers connected through internet with a virus, thereby malfunctioning a system of corresponding destination and consuming bandwidth of a line so that a service is not normally provided. The DDoS attack includes bandwidth exhaustion attack, resource saturation attack, etc.

In the SDN, size of a flow table in a controller and a switch as a network device is limited, due to limitation of memory size. The DDoS attack may inject successive spoofing request to a packet, for the purpose of using the limitation. Accordingly, amount of packets received to the controller increases abnormally, and thus the controller cannot process normally traffic. An attacker may deteriorate performance of the network or turn off compulsory the system through continuous attacks.

In recent, many researchers have been studied methods of detecting and reducing the DDoS attack in the SDN. A method of perfectly detecting and protecting the DDoS attack applied to the controller of the SDN has not been developed.

### SUMMARY

Accordingly, the invention is provided to substantially obviate one or more problems due to limitations and disadvantages of the related art. One embodiment of the invention provides an SDN for detecting DDoS attacks using artificial intelligence and a controller included in the same.

Other features of the invention may be thought by a person in an art through following embodiments.

In one embodiment, the invention provides a software defined network comprising: a controller arranged on a control plane of the software defined network;

and a plurality of switches arranged on a data plane of the software defined network. Here, each of the switches collects flow which is aggregation of packets and transmits feature information concerning the flow to the controller, and the controller detects a DDoS attack by using the feature information concerning the flow and a back propagation neural network (BPNN).

The controller may generate a DDoS detection model by inputting feature information of pre-prepared learning flow to the BPNN, and detect the DDoS attack by inputting the feature information concerning the flow to the DDoS detection model.

The feature information concerning the flow may include information concerning a number of packets in the flow, information concerning a number of bytes in the flow, information concerning a period during which the flow is collected and information concerning protocol of the flow.

In another embodiment, the invention provides a controller included in a software defined network comprising: a communication unit configured to receive feature information concerning a flow which is aggregation of packets from each of switches included in the software defined network; and a detection unit configured to detect a DDoS attack by using the feature information concerning the flow and a back propagation neural network (BPNN).

An SDN of the invention may detect and reduce effectively DDoS attacks applied to a controller.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a basic architecture of SDN;

FIG. 2 is a view illustrating OpenFlow used in SDN;

FIG. 3 is a view illustrating coarse structure of an SDN according to one embodiment of the invention;

FIG. 4 is a block diagram illustrating a controller according to one embodiment of the invention; and

FIG. 5 is a view illustrating a concept of BPNN used in the invention.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included.

That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

Hereinafter, a software defined network SDN of the invention will be briefly described.

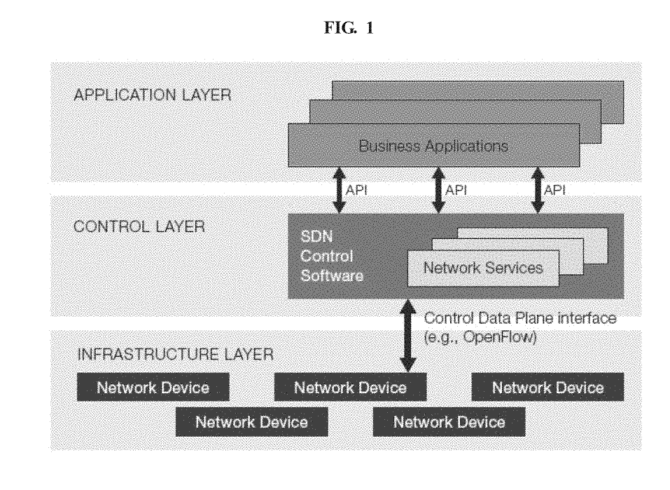

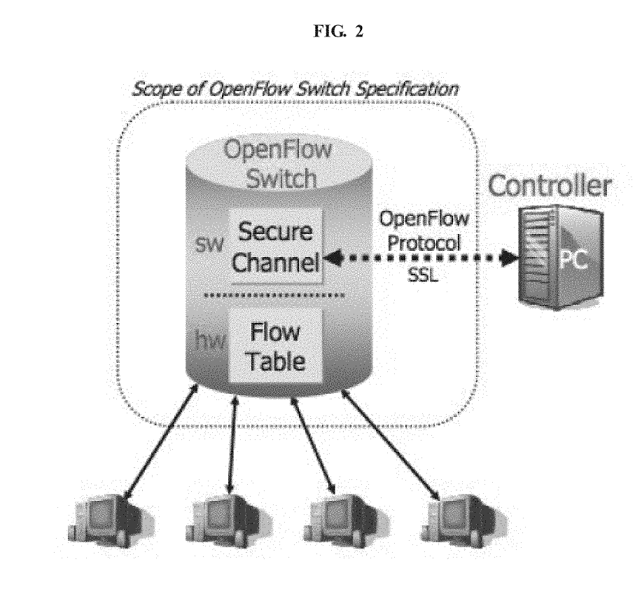

FIG. 1 is a view illustrating a basic architecture of SDN, and FIG. 2 is a view illustrating OpenFlow used in SDN.

In FIG. 1, layers of the SDN are divided into an infrastructure layer corresponding to a data plane, a control layer corresponding to a control plane and an application layer. The data layer is controlled through a specific interface of the SDN, and it is in charge of data transmission. The control layer controls flowing of data, and it determines whether it routes, delivers or rejects the flowing of data through an application and a network service. Additionally, the control layer organizes operations of the data layer and delivers the organization to the application layer in type of an application programming interface API. The application layer may perform various functions of a network by using APIs provided from the control layer.

In traditional network, network equipments such as a router or a switch take charge of traffic control and a rule. Hence, router information of the network is stored in the switch and the router. This network architecture has the problem in that a manager arranges related internet equipments whenever the network is changed and a data center or a group network environment wastes resources due to frequent network changing.

An OpenFlow is a technique, used as an interface standard between the controller and the network equipment, for supplementing the above problem of the traditional network. Referring to FIG. 2, the OpenFlow may manage the network under dividing the control plane and the data plane, thereby separating a function of controlling network traffic and a function of delivering data and controlling the network by using built software. If an OpenFlow protocol is used, the control plane and the data plane may be made with software not hardware. Furthermore, new function may be rapidly realized by installing the software to a general server.

The OpenFlow may generate one information by combining header information of protocol layer 1 to protocol layer 4 and designate operation of a packet (frame) by using the one information. If a program of the control plane is amended, a user may generate freely new protocol in the range of the protocol layer 1 to the protocol layer 4 and achieve a network optimized to a specific service or application. That is, the OpenFlow divides the function of controlling the packet and the function of delivering the packet and controls the network via the programming.

The SDN capable of detecting the DDoS attack of the invention will be described in detail with reference to the above description.

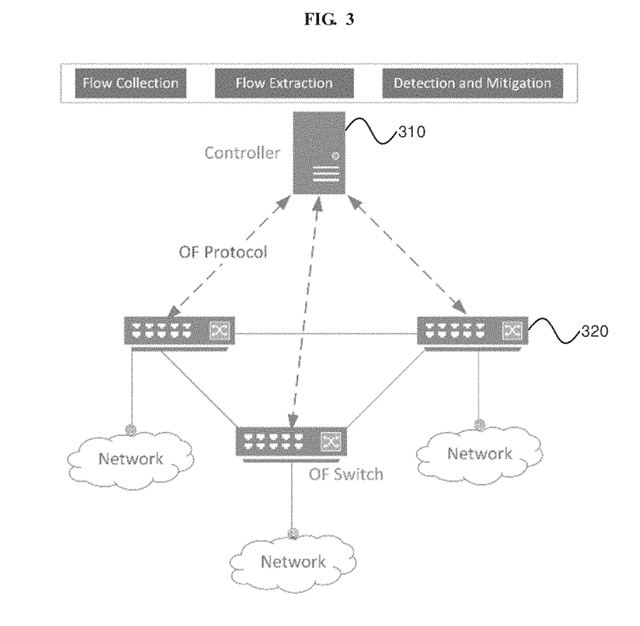

FIG. 3 is a view illustrating coarse structure of an SDN according to one embodiment of the invention.

In FIG. 3, the SDN 300 of the present embodiment uses for example an OpenFlow(OF) interface, and includes a controller 310 and plural switches 320.

The controller 310 indicates an OF controller corresponding to the OpenFlow interface, and is arranged on the control plane. The controller 310 performs every control instruction of the network and delivering of data traffic, and controls directly whole network.

Each of the switches 320 means an OF switch corresponding to the OpenFlow, is arranged on the data plane, and is connected to corresponding external network.

That is, the controller 310 transmits instructions to each of the switches 320. Each of the switches 320 transmits packets to a destination, amends or discards the packets according to a received instruction. The controller 310 delivers a forwarding method of the packet or a priority value of a VLAN, etc. to the switch 320 by using the OpenFlow protocol so that the switch 320 operates according to the delivered forwarding method or the priority value. The switch 320 inquires error information and information concerning a packet not corresponding to a pre-registered flow entry to the controller, receives determination of the controller in accordance with the inquiring and processes the packet in response to the determination.

Specially, the controller 310 performs path computation as a main function, and determines a path based on several parameters when the packet is transmitted. The parameters include weight of a path designated by the user or load distribution condition, etc. as well as shortest path SPF or line speed. Path information computed by the controller 310 is transmitted to the switch 320 via transport layer security TLS or general TCP connection and then it is stored in a flow table. Subsequently, the switch 320 verifies the flow table whenever it receives the packet and transmits corresponding frame through a designated path.

Each of the switches 320 may collect flow which is aggregation of packets received through external network. That is, the flow is collected during constant period of time, and means aggregation of successive packets having the same feature, wherein the packets are transmitted through the same external network. A flow entry includes wide range of useful statistical information. The statistical information includes a period during which the flow is collected, a number of packets in the flow, a number of bytes in the flow, a protocol of the flow, an IP address, a service port and so on.

In one embodiment, each of the switches 320 may compute feature information concerning the flow, and transmit the computed feature information to the controller 310. Here, the feature information may be varied depending on a kind of network traffic. The feature information of the present embodiment may be 4-tuple information, and include information concerning a number of the packets in the flow, information concerning a number of the bytes in the flow, information concerning the period during which the flow is collected and information concerning the protocol of the flow (TCP SYN, ICMP, UDP).

The controller 310 detects the DDoS attacks by using the feature information concerning flow received from each of the switches 320 and a back propagation neural network BPNN.

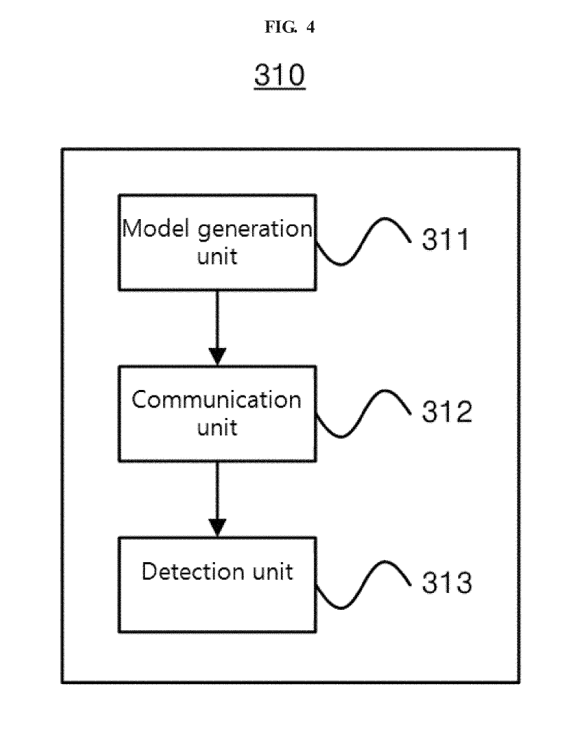

Hereinafter, an operation of the controller 310 of the invention will be described in detail with reference to a drawing FIG. 4.

FIG. 4 is a block diagram illustrating a controller according to one embodiment of the invention.

In FIG. 4, the controller 310 of the present embodiment may include a model generation unit 311, a communication unit 312 and a detection unit 313.

The model generation unit 311 generates a DDoS detection model by inputting feature information of pre-prepared learning flow to the BPNN. Here, the feature information of the learning flow may be also received in advance through the communication unit 312.

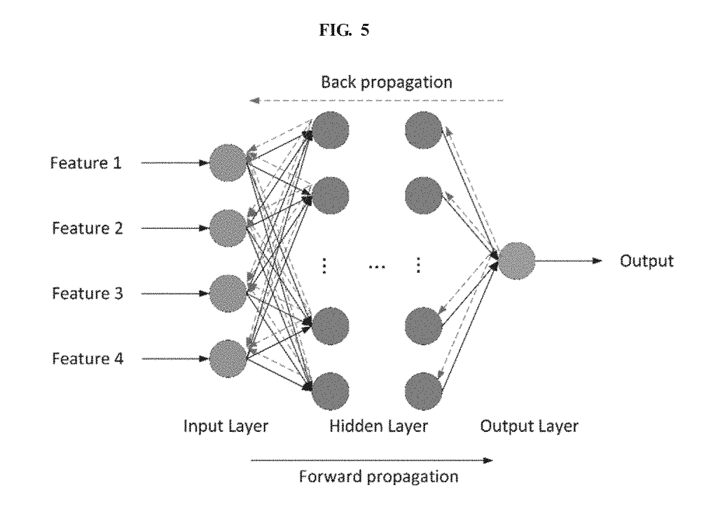

Hereinafter, a concept of the BPNN used in the invention will be described with reference to a drawing FIG. 5.

An artificial neural network indicates a model thought from a brain in which neurons for performing simple function are gathered and the gathered neurons perform a complicated function. A node or perceptron of the artificial neural network performs a function of the neuron. That is, like an operation of one neuron delivering a signal having a threshold more than constant value to another neuron, the node of the artificial neuron network calculates an inputted signal with an activation function, and delivers the calculated result and weight to another node.

The BPNN as one of the artificial neural network may have a structure shown in FIG. 5. The BPNN is an algorithm of reducing an error by propagating the error between a real value and a value calculated by a machine learning model in inverse order.

Referring to FIG. 5, the BPNN includes an input layer, a hidden layer which is a middle layer and an output layer. The BPNN amends inversely the weight and a value of the hidden layer to reduce the error, when the error exists between a value of the output layer calculated by the BPNN and the real value.

Particularly, the input layer, the hidden layer and the output layer includes one or more neurons. Each of neurons included in the input layer receives input information, and delivers the input information to each of neurons included in the middle layer.

The middle layer is an internal information processing layer which is in charge of information computation. The middle layer may include a single hidden layer or plural hidden layers, depending on demand of sensitivity. Information computed by the middle layer is transmitted from a neuron of final hidden layer to a neuron of the output layer.

An output value is outputted if a real output value matches with an expectation output value or a learning procedure reaches the upper limit, or otherwise a back propagation starts. Weight of each of the layers may be adjusted according to a gradient descent algorithm while the back propagation is performed. This process is continuously performed until a network output error downs to an allowable level or the learning process reaches the preset upper limit.

The DDoS detection model may have the same structure as the BPNN described above.

Briefly, the model generation unit 311 inputs the information concerning a number of packets in the learning flow, information concerning a number of bytes in the learning flow, information concerning period during which the learning flow is collected and information concerning protocol of the learning flow, which are feature information of the learning flow, to the input layer of the BPNN. The model generation unit 311 generates the DDoS detection model by repeating a learning process by multiple times.

The communication unit 312 receives the feature information concerning the flow transmitted from each of the switches 320. Here, as described above, the feature information concerning the flow may include the information concerning a number of the packets in the flow, the information concerning a number of the bytes in the flow, the information concerning period during which the flow is collected, and the information concerning the protocol of the flow.

The detection unit 313 detects the DDoS attack by inputting the feature information concerning the flow received from the switches 320 to the DDoS detection model. That is, the feature information concerning the flow received from the switches 320 is inputted to the input layer of the DDoS detection model, and the output layer of the DDoS detection model determines whether the flow is malicious flow or normal flow.

In the event that the detection unit 313 determines that the flow is malicious flow, the controller 310 transmits flow addition request through the communication unit 312, to block the flow. This rule is executed by the switch 320 for blocking next flow. Here, following instructions are transmitted from the controller 310 to the switch 320.
instruction of activating forwarding to the switch: ovs-ofctl add-flow s1 priority=10,action=normal
instruction of blocking malicious traffic of a host: ovs-ofctl add-flow s1 priority=11, dl_type=0x0800, nw_src=10.0.0.1, action=drop
instruction of restoring again traffic: ovs-ofctl-strict del-flows s1 priority=11, dl_type=0x0800, nw_src=10.0.0.1

Shortly, the SDN 300 and the controller 310 included in the same according to the invention may detect accurately the DDoS attack by using the BPNN which is an artificial intelligence.

Components in the embodiments described above can be easily understood from the perspective of processes. That is, each component can also be understood as an individual process. Likewise, processes in the embodiments described above can be easily understood from the perspective of components. The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. A software defined network comprising:
a controller arranged on a control plane of the software defined network; and
a plurality of switches arranged on a data plane of the software defined network,
wherein each of the switches collects flow which is aggregation of packets and transmits feature information concerning the flow to the controller, and the controller detects a DDoS attack by using the feature information concerning the flow and a back propagation neural network (BPNN).

2. The software defined network of claim 1, wherein the controller generates a DDoS detection model by inputting feature information of pre-prepared learning flow to the BPNN, and detects the DDoS attack by inputting the feature information concerning the flow to the DDoS detection model.

3. The software defined network of claim 2, wherein the feature information concerning the flow includes information concerning a number of packets in the flow, information concerning a number of bytes in the flow, information concerning a period during which the flow is collected and information concerning protocol of the flow.

4. A controller included in a software defined network comprising:
a communication unit configured to receive feature information concerning a flow which is aggregation of packets from each of switches included in the software defined network; and
a detection unit configured to detect a DDoS attack by using the feature information concerning the flow and a back propagation neural network (BPNN).

5. The controller of claim 4, further comprising:
a model generation unit configured to generate a DDoS detection model by inputting feature information of pre-prepared learning flow to the BPNN,
wherein the detection unit detects the DDoS attack by inputting the feature information concerning the flow to the DDoS detection model.
